(19) United States
(12) Patent Application Publication
(10) Pub. No.: US 2022/0083938 A1
(43) Pub. Date: Mar. 17, 2022

(54) TRANSPORTATION PLANNING SYSTEM AND TRANSPORTATION PLANNING METHOD

(71) Applicant: Hitachi, Ltd., Tokyo (JP)

(72) Inventors: Akane SETO, Tokyo (JP); Junko HOSODA, Tokyo (JP); Futoshi KOIKE, Tokyo (JP); Naoko KISHIKAWA, Tokyo (JP); Kazuya UYAMA, Tokyo (JP)

(21) Appl. No.: 17/467,921

(22) Filed: Sep. 7, 2021

(30) Foreign Application Priority Data
Sep. 15, 2020 (JP) 2020-154475

(51) Int. Cl. G06Q 10/06

(52) U.S. Cl. CPC G06Q 10/06311

(57) ABSTRACT

A transportation planning system provides a transportation plan for reducing at least a plan change amount in response to a variation in a transportation amount and a change in a transportation resource. A storage unit stores transportation amount information on an article based on an order, transportation resource information on the article, and transportation resource arrangement plan information indicating a preset transportation resource arrangement plan. The control unit generates transportation draft plans of an article based on an order using a transportation resource available for transportation of the article, generates, for each of the transportation draft plans, a transportation resource arrangement draft plan for implementing the transportation, and calculates a change amount of a distribution cost when the transportation resource arrangement draft plan is adopted with respect to a distribution cost based on the preset transportation resource arrangement plan, for each of the plurality of transportation resource arrangement draft plans.

### CLAIM OF PRIORITY

The present application claims priority from Japanese patent application JP 2020-154475 filed on Sep. 15, 2020, the content of which is hereby incorporated by reference into this application.

### TECHNICAL FIELD

The present invention relates to a technique for making a transportation plan.

### BACKGROUND ART

As a transportation planning technique, JP-A-2017-167757 (PTL 1) discloses a technique. The publication discloses that “a delivery planning system includes: an initial condition setting unit that receives an input of information on a delivery object, a delivery subject, a demand quantity and a supply quantity of the delivery object for each delivery base that is a place where any one of the delivery object and a delivery unit that moves the delivery subject stays, information on one or a plurality of departure bases indicating initial positions of the delivery subject and the delivery unit, information on an available delivery unit and delivery subject at the departure base, and information on a delivery deadline, and sets an initial condition in a delivery plan; and a delivery plan generation unit that calculates point information in which the delivery base, the departure base, and a time based on the delivery start is combined, and branch information indicating flow rates of the delivery object, the delivery subject, and the delivery unit related to the delivery between two pieces of point information related to the delivery of the delivery object among the point information, and generates at least one set of the branch information in a case of delivering the delivery object satisfying the demand quantity within the delivery deadline to the delivery base for which the demand quantity is set”.

As a technique for changing a transportation plan, JP-A-2013-129510 (PTL 2) discloses a technique. The publication discloses that “a transportation management system for managing a transportation service includes: a transportation service information storage unit that stores setting information including a departure and arrival diagram and a vehicle type for a transportation service planned to be operated; a performance information storage unit that stores performance information on a loading amount actually loaded in the transportation service; and a control unit that is connected to a client terminal installed at each base. The control unit includes: a unit that acquires an additional transportation request including a setting condition of additional transportation from the client terminal; a unit that uses the setting information of transportation service stored in the transportation service information storage unit to search whether a transportation service similar to the setting condition of the additional transportation request is stored in the transportation information storage unit; a transportation service candidate specifying unit that specifies a transportation service as a transportation candidate when the transportation service satisfying a condition regarding a departure place and a destination included in the setting condition is extracted from the transportation service information storage unit; a unit that predicts a loading amount of a vehicle of the specified transportation service from the loading amount stored in the performance information storage unit; and a unit that outputs the transportation candidate to the client terminal when the loading amount included in the setting condition of the additional transportation can be loaded in the transportation candidate”.

### CITATION LIST

### Patent Literature

PTL 1: JP-A-2017-167757

PTL 2: JP-A-2013-129510

### SUMMARY OF INVENTION

### Technical Problem

A transportation company makes a monthly transportation plan for a regular service, and arranges transportation resources, such as a vehicle, a shipping worker, and a driver, that serve as a main body or unit of shipping and transportation. However, a transportation amount varies on a daily basis, and the transportation resource may be changed on the daily basis, such as driver absenteeism. If the transportation resource is always arranged excessively in order to cope with the variation and the change, all packages can be transported, and a transportation delay can be prevented. However, a distribution cost may increase. Therefore, it is necessary to make a daily transportation plan by making a plan change to arrange additional transportation resources each time in accordance with a variation in the transportation amount and a change in the transportation resource.

A shipping plan for the regular service and a transportation plan for a driver are made based on a transportation plan for the regular service. The plans are plans familiar to shipping workers and drives. When the transportation plan for the regular service is greatly changed to the daily transportation plan, it is necessary to greatly change the shipping plan and the transportation plan for the drivers. Therefore, an unfamiliar plan is made. Since the unfamiliar plan induces a shipping and transportation error, a loss due to the shipping and transportation error may increase in addition to an increase in a load on a worker. Therefore, it is desirable that a change amount from the transportation plan for the regular service to the daily transportation plan is small. On the other hand, from a viewpoint of cost, it is desirable to reduce the entire distribution cost including, for example, a vehicle cost and a work cost, in addition to the loss due to the shipping and transportation error.

In PTL 1, transportation plan information for the regular service is not taken into consideration when making a daily plan. Therefore, the shipping plan and the transportation plan that are significantly different from those of the regular service may be made. PTL 2 does not consider a case where a transportation request for the regular service is canceled. In this case, the possibility that a vehicle cost or a labor cost of the driver can be reduced by reducing the number of vehicles or drivers cannot be considered. Therefore, the possibility that the distribution cost can be reduced cannot be considered.

Therefore, an object of the invention is to provide a technique for making a transportation plan for reducing a plan change amount or a plan change amount and a distribution cost in response to a variation in a transportation amount and a change in a transportation resource.

### Solution to Problem

One representative transportation planning system according to the invention for solving at least one of the above problems is as follows. That is, a transportation planning system includes: a control unit and a storage unit connected to the control unit. The storage unit stores transportation amount information indicating a transportation source, a transportation destination, and a transportation amount of an article based on an order, transportation resource information indicating a transportation resource available for transportation of the article, and transportation resource arrangement plan information indicating a preset transportation resource arrangement plan. The control unit is configured to generate, based on the transportation amount information and the transportation resource information, a plurality of transportation resource draft plans of the article based on the order using the transportation resource available for the transportation of the article, generate, for each of the transportation draft plans, a transportation resource arrangement draft plan for implementing the transportation, and calculate, based on the transportation resource arrangement plan information, a change amount of a distribution cost when the transportation resource arrangement draft plan is adopted with respect to a distribution cost based on the preset transportation resource arrangement plan, for each of the plurality of transportation resource arrangement draft plans.

### Advantageous Effect

According to an aspect of the invention, it is possible to make a transportation plan for reducing at least the plan change amount in response to the variation in the transportation amount and the change in the transportation resource. Problems, configurations, and effects other than those described above will become apparent from the following description of embodiments.

### BRIEF DESCRIPTION OF DRAWINGS

FIG. 1 is a diagram showing an example of a configuration of a transportation planning system and an example of a functional configuration of a transportation planning device according to a first embodiment.

FIG. 2 is a diagram showing an example of a hardware configuration of the transportation planning system according to the first embodiment.

FIG. 3 is a flowchart showing an example of transportation planning processing according to the first embodiment.

FIG. 4 is a diagram showing an example of a data structure of transportation amount information according to the first embodiment.

FIG. 5 is a diagram showing an example of a data structure of transportation resource information according to the first embodiment.

FIG. 6 is a diagram showing an example of a data structure of base information according to the first embodiment.

FIG. 7 is a diagram showing an example of a data structure of movement cost information according to the first embodiment.

FIG. 8 is a diagram showing an example of a data structure of transportation resource arrangement plan information according to the first embodiment.

FIG. 9 is a diagram showing an example of a data structure of preparation progress information according to the first embodiment.

FIG. 10 is a diagram showing an example of a data structure of change amount evaluation index information according to the first embodiment.

FIG. 11 is a diagram showing an example of a data structure of transportation progress information according to the first embodiment.

FIG. 12 is a diagram showing an example of a data structure of transportation draft plan information according to the first embodiment.

FIG. 13 is a flowchart showing an example of plan change amount calculation processing using the change amount evaluation index information and performed by a plan change amount calculation unit according to the first embodiment.

FIG. 14 is a diagram showing an example of a data structure of transportation resource arrangement draft plan information according to the first embodiment.

FIG. 15 is a flowchart showing an example of change amount calculation processing of an attribute of the transportation resource performed by the plan change amount calculation unit according to the first embodiment.

FIG. 16 is a diagram showing an example of a display screen of a result summary displayed on a display device of the transportation planning device according to the first embodiment.

FIG. 17 is a diagram showing an example of a display screen of a change amount displayed on the display device of the transportation planning device according to the first embodiment.

FIG. 18 is a diagram showing an example of a display screen of an in-vehicle terminal according to the first embodiment.

FIG. 19 is a diagram showing an example of a display screen of a shipping plan management terminal according to the first embodiment.

FIG. 20 is a diagram showing an example of a data structure of evaluation index information according to a second embodiment.

### DESCRIPTION OF EMBODIMENTS

Hereinafter, embodiments will be described below with reference to the drawings. In the present embodiment, same components are denoted by same reference numerals in principle, and a repetitive description thereof is omitted. It should be noted that the present embodiment is merely an example for implementing the invention, and does not limit the technical scope of the invention.

### First Embodiment

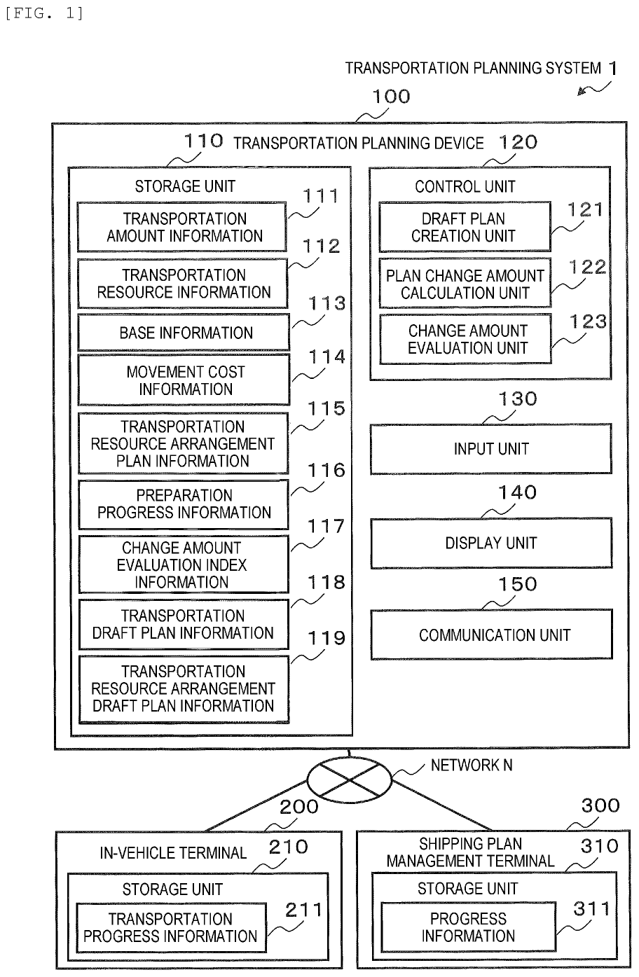

FIG. 1 is a diagram showing an example of a configuration of a transportation planning system 1 and an example of a functional configuration of a transportation planning device 100 according to a first embodiment.

The transportation planning system 1 includes the transportation planning device 100, and an in-vehicle terminal 200 and a shipping plan management terminal 300 that are communicably connected to the transportation planning device 100 via a network

N.

The transportation planning device 100 includes a storage unit 110, a control unit 120, an input unit 130, a display unit 140, and a communication unit 150.

The storage unit 110 stores transportation amount information 111, transportation resource information 112, base information 113, movement cost information 114, transportation resource arrangement plan information 115, preparation progress information 116, change amount evaluation index information 117, transportation draft plan information 118, and transportation resource arrangement draft plan information 119.

The transportation amount information 111 is information on a transportation amount at a time point of planning. The transportation resource information 112 is information on a transportation resource that has been arranged at the time point of planning and a transportation resource that can be additionally arranged. The base information 113 is information on bases of a pickup source and a delivery destination. The movement cost information 114 is information of defining a cost required for movement between two bases. The transportation resource arrangement plan information 115 is arrangement plan information of the transportation resource that has been made according to the transportation plan for a regular service. The preparation progress information 116 is information related to a progress of a transportation preparation work that progresses according to the transportation plan for the regular service. The change amount evaluation index information 117 is information on a weight coefficient for each evaluation index in calculation of the change amount. The transportation draft plan information 118 is information on a draft transportation plan created by the control unit 120. The transportation resource arrangement draft plan information 119 is information on a transportation resource arrangement draft plan created by the control unit 120.

The control unit 120 includes a draft plan creation unit 121, a plan change amount calculation unit 122, and a change amount evaluation unit 123. The draft plan creation unit 121 creates a draft transportation plan after change using the transportation amount information 111, the transportation resource information 112, the base information 113, and the movement cost information 114, and stores the transportation draft plan in the transportation draft plan information 118. The plan change amount calculation unit 122 calculates a change amount of the created transportation draft plan using the transportation resource information 112, the transportation resource arrangement plan information 115, the preparation progress information 116, and the changed transportation draft plan. At this time, the change amount evaluation index information 117 may be used. The change amount evaluation unit 123 stores, as an optimal plan, a plan having a smallest change amount among transportation draft plans for each of which the change amount is calculated.

The input unit 130 receives an input operation from a user.

The display unit 140 displays the transportation plan made by the control unit 120 on a display device.

The communication unit 150 transmits or receives information between the in-vehicle terminal 200 and the shipping plan management terminal 300.

The in-vehicle terminal 200 is mounted on a transportation vehicle, transmits transportation progress information 211 of the vehicle stored in a storage unit 210 to the communication unit 150, and receives the transportation plan for each transportation vehicle transmitted from the communication unit 150.

The shipping plan management terminal 300 is disposed in a warehouse, transmits progress information 311 stored in a storage unit 310 to the communication unit 150, and receives the transportation plan transmitted from the communication unit 150.

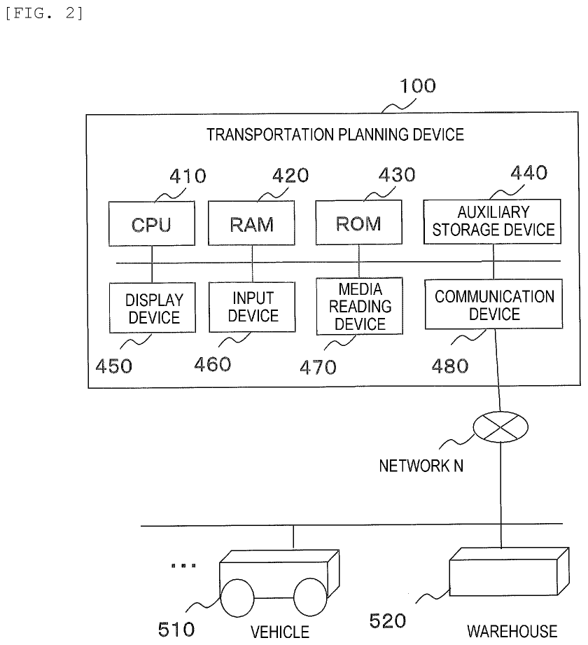

FIG. 2 is a diagram showing an example of a hardware configuration of the transportation planning system 1 according to the first embodiment.

The transportation planning device 100 includes a central processing unit (CPU) 410, a random access memory (RAM) 420, a read only memory (ROM) 430, an auxiliary storage device 440, a display device 450, an input device 460, a media reading device 470, and a communication device 480. The transportation planning device 100 can transmit data to and receive data from the in-vehicle terminal 200 (omitted in FIG. 2) of a vehicle 510 and the shipping plan management terminal 300 (omitted in FIG. 2) of a warehouse 520 via the communication device 480.

The CPU 410 executes various calculations. The RAM 420 is a memory that stores programs to be executed by the CPU 410, data, and the like. The ROM 430 is a memory that stores programs and the like necessary for starting the transportation planning system. The auxiliary storage device 440 is, for example, a device such as a hard disk drive (HDD). The display device 450 is, for example, a device such as a liquid crystal display. The input device 460 is, for example, a device such as a keyboard. The media reading device 470 is a device that reads information from a portable storage medium such as a universal serial bus (USB) memory. The communication device 480 transmits information to or receives information from an external device via the network N.

For example, the control unit 120 shown in FIG. 1 is a function of the CPU 410, and the storage unit 110 function as the RAM 420, the ROM 430, and the auxiliary storage device 440. For example, the information stored in the storage unit 110 shown in FIG. 1 is stored in the RAM 420 or the like. A function of each unit in the control unit 120 is implemented by the CPU 410 executing a program stored in the ROM 430 or the like. The input unit 130 shown in FIG. 1 functions as the input device 460, the display unit 140 functions as the display device 450, and the communication unit 150 functions as the communication device 480.

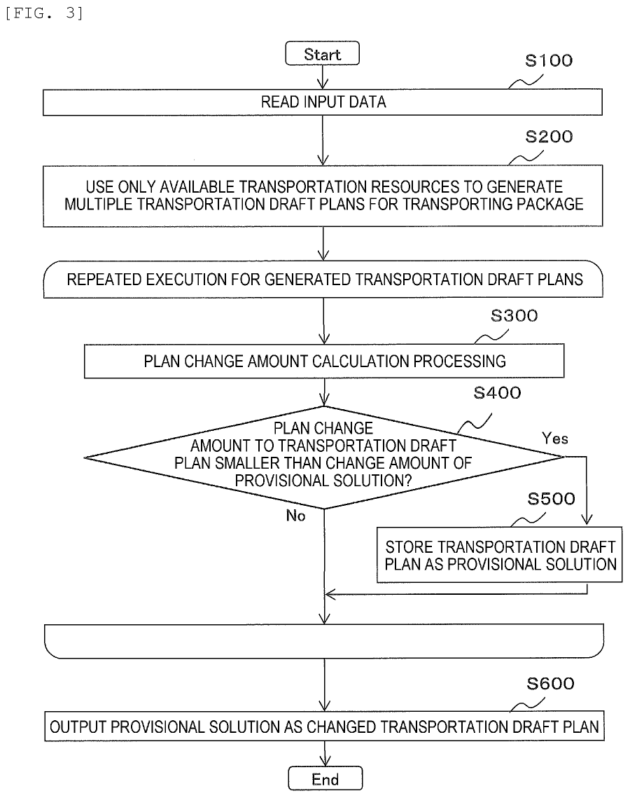

FIG. 3 is a flowchart showing an example of transportation planning processing according to the first embodiment.

The transportation planning processing is started, for example, when the input unit 130 receives an input. When the processing is started, the transportation planning device 100 reads input data from the in-vehicle terminal 200, the shipping plan management terminal 300, and the input device 460 into the storage unit 110 (S100).

Next, the draft plan creation unit 121 creates a plurality of transportation draft plans for transporting a package using only available transportation resources included in the transportation resource information 112, and stores the transportation plans in the transportation draft plan information 118 (S200).

Thereafter, the transportation planning device 100 performs steps S300 to S500 for all the created transportation draft plans.

In step S300, the plan change amount calculation unit 122 performs the plan change amount calculation processing of calculating a plan change amount from the transportation plan (for example, monthly transportation draft plan) for the regular service to the transportation plan.

In step S400, the change amount evaluation unit 123 determines whether the plan change amount calculated in the immediately preceding step S300 is smaller than a change amount of a provisional transportation plan (provisional solution) stored at that time point.

When it is determined in step S400 that the change amount is smaller than the change amount of the provisional transportation plan stored at that time point, the processing moves to step S500, and the change amount evaluation unit 123 stores, as the provisional transportation plan, the transportation draft plan for which the plan change amount is calculated in immediately preceding step S300 (that is, the provisional transportation plan is updated).

Finally, in step S600, the provisional transportation plan stored at that time point is output to the display unit 140 as the changed transportation plan. That is, the provisional transportation plan stored at the time point when the steps S300 to S500 are completed for all the created transportation draft plans is specified as the transportation plan having the smallest plan change amount among all the transportation draft plans. The communication unit 150 transmits the changed transportation plan to the in-vehicle terminal 200 and the shipping plan management terminal 300 via the network N.

Hereinafter, each step in FIG. 3 will be described.

In step S100, the storage unit 110 reads the transportation amount information 111, the transportation resource information 112, the base information 113, the movement cost information 114, and the transportation resource arrangement plan information 115 from the input device 460. Further, the change amount evaluation index information 117 may be read. Thereafter, the storage unit 110 reads the transportation resource information 112 for each vehicle, confirms the transportation progress information 211 stored in the storage unit 210 of the in-vehicle terminal 200, and deletes the vehicle from the transportation resource information 112 when a date and time at which the vehicle can start transporting next time is a date and time of a planning target or later. Further, the storage unit 110 reads the progress information 311 from the shipping plan management terminal 300 into the preparation progress information 116.

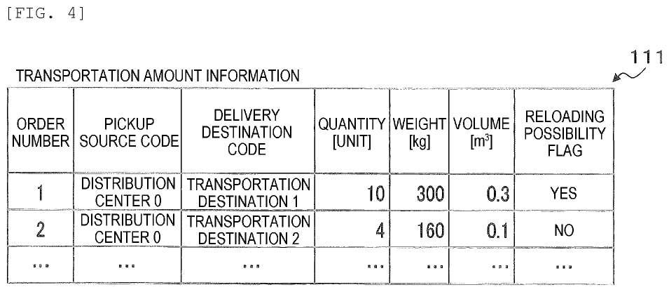

FIG. 4 is a diagram showing an example of a data structure of the transportation amount information 111 according to the first embodiment.

The transportation amount information 111 includes, as items, at least an “order number” for identifying an order, a “pickup source code” indicating a pickup source, a “delivery destination code” indicating a delivery destination, a “quantity” indicating the number of packages, a “weight” indicating a total weight of the packages, a “volume” indicating a total volume of the packages, and a “reloading possibility flag” indicating whether the packages can be reloaded. The “quantity” indicating the number of the packages, the “weight” indicating the total weight of the packages, and the “volume” indicating the total volume of the packages may be substituted by, for example, the “quantity”, the “weight”, the “volume”, a partial combination thereof, or a “package amount” indicating the amount of the packages.

FIG. 5 is a diagram showing an example of a data structure of the transportation resource information 112 according to the first embodiment.

The transportation resource information 112 includes at least vehicle information 112a, driver information 112b, and shipping worker information 112c.

The vehicle information 112a includes at least a “vehicle name” for identifying a vehicle, a “load number upper limit” indicating an upper limit of the number of loads of the vehicle, a “load weight upper limit” indicating an upper limit of a load weight of the vehicle, a “load volume upper limit” indicating an upper limit of a load volume of the vehicle, a “vehicle unit price” indicating an arrangement fee for one vehicle, an “operation unit price” indicating a fee in units of vehicle operation time, and a “cancellation fee” indicating a ratio of the cancellation fee to the vehicle unit price when the vehicle arrangement is canceled. A “loadable upper limit” may be substituted by, for example, the “load number upper limit”, the “load weight upper limit”, the “load volume upper limit”, a partial combination thereof, or a “loadable amount upper limit” indicating a loadable amount upper limit of the vehicle.

The driver information 112b includes, at least, a “driver code” for identifying a driver, a “labor cost” indicating a fee for each operation time of the driver, an “assigned area” indicating an area to which the driver is accustomed to transportation, a “transportation impossible area” indicating an area to which the package cannot be transported due to a reason that the driver does not have a pass permit, and a “transportation error risk coefficient” indicating a level of possibility that the driver may make a transportation error.

The shipping worker information 112c includes at least a “worker code” for identifying a shipping worker, a “workable time zone” indicating a time zone in which the worker can work, a “labor cost” indicating a fee for the worker in units of work time, and a “shipping error risk coefficient” indicating a level of possibility that the worker may make a shipping error.

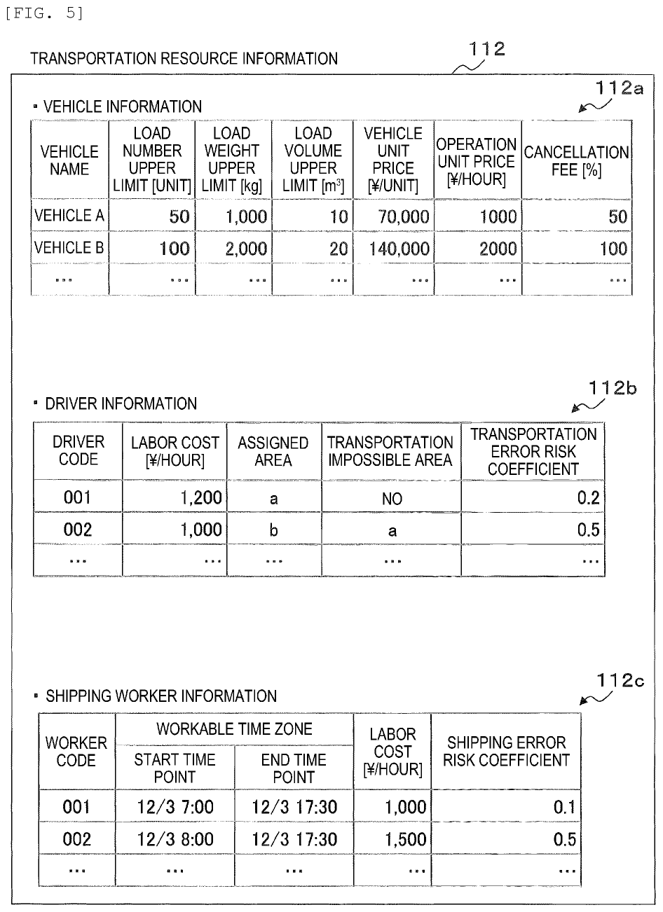

FIG. 6 is a diagram showing an example of a data structure of the base information 113 according to the first embodiment.

The base information 113 includes at least a “base name” for identifying a base and an “area name” for identifying an area to which the base belongs. Here, the base is, for example, a distribution base such as a distribution center of a transportation source and a transportation destination.

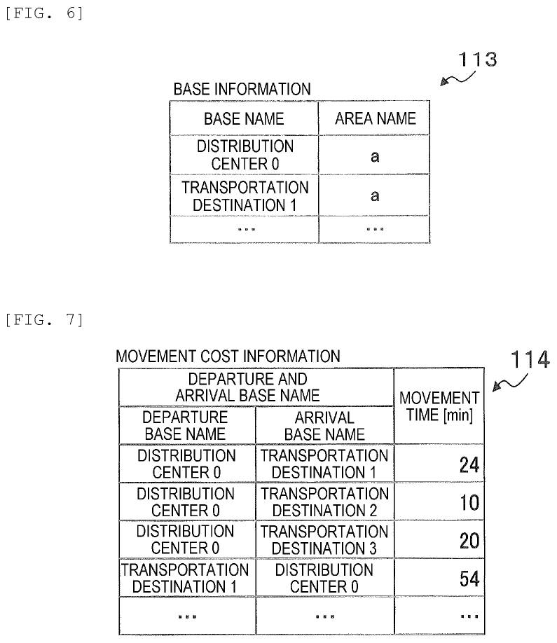

FIG. 7 is a diagram showing an example of a data structure of the movement cost information 114 according to the first embodiment.

The movement cost information 114 includes at least a “departure base name” for identifying a departure base of movement, an “arrival base name” for identifying an arrival base of the movement, and a “movement time” indicating a movement time in a case of moving from the departure base to the arrival base.

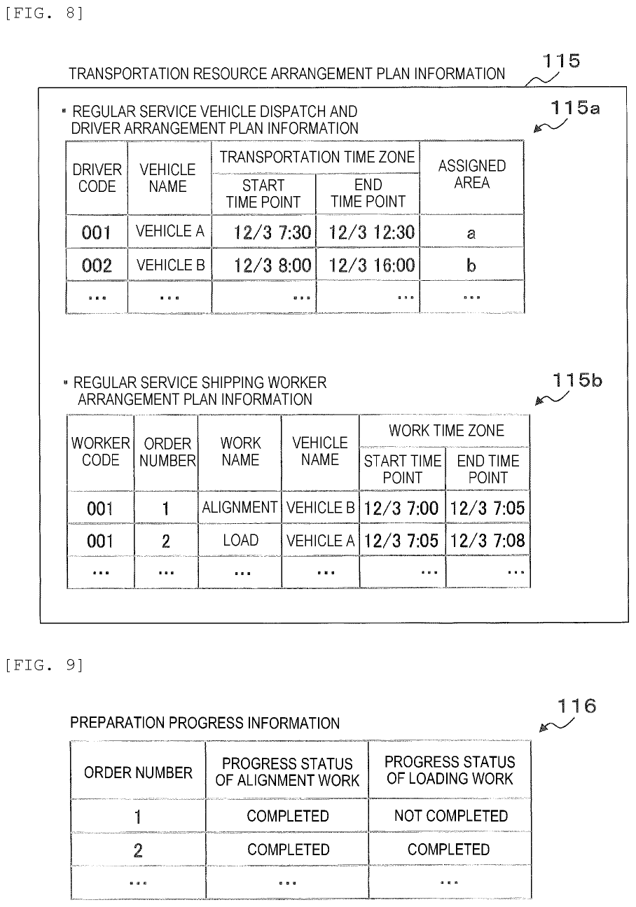

FIG. 8 is a diagram showing an example of a data structure of the transportation resource arrangement plan information 115 according to the first embodiment.

The transportation resource arrangement plan information 115 includes at least regular service vehicle dispatch and driver arrangement plan information 115a and regular service shipping worker arrangement plan information 115b.

The regular service vehicle dispatch and driver arrangement plan information 115a includes at least a “driver code” for identifying a driver, a “vehicle name” for identifying a vehicle, a “transportation time zone” indicating a time zone during which the driver is engaged in a transportation work, and an “assigned area” indicating an assigned area of the driver. The “transportation time zone” may be substituted by, for example, a “transportation time” indicating a time during which the driver takes a ride on the vehicle for transportation.

The regular service shipping worker arrangement plan information 115b includes at least a “worker code” for identifying a worker, an “order number” for identifying an order of a work target, a “work name” indicating a work performed by the worker, a “vehicle name” for identifying a vehicle of the work target, and a “work time zone” indicating a time zone during which the worker is involved in a shipping work. The “work time zone” may be substituted by, for example, a “work time” indicating a time during which the worker performs the work. The regular service vehicle dispatch and driver arrangement plan information 115a may further include a “quantity” indicating the number of packages of the work target, a “weight” indicating a total weight, or a “volume” indicating a total volume.

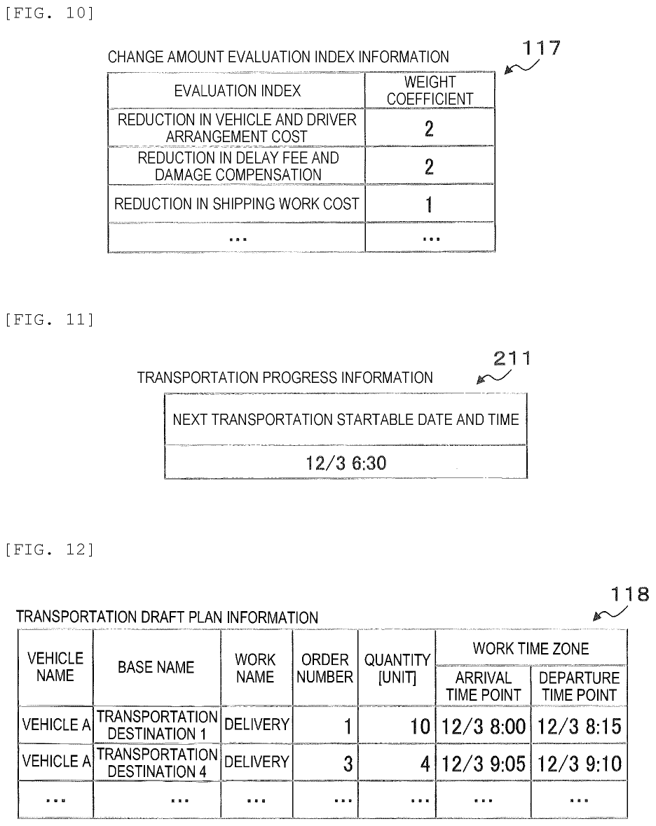

FIG. 9 is a diagram showing an example of a data structure of the preparation progress information 116 according to the first embodiment.

The preparation progress information 116 includes an “order number” for identifying a package, a “progress status of alignment work” indicating whether the packages are aligned, and a “progress status of loading work” indicating whether the packages are loaded.

FIG. 10 is a diagram showing an example of a data structure of the change amount evaluation index information 117 according to the first embodiment.

The change amount evaluation index information 117 includes at least an “evaluation index” that is an evaluation index of the plan change amount and a “weight coefficient” that indicates a weight coefficient of each evaluation index in the plan change amount calculation.

In the example of FIG. 10, “reduction in vehicle and driver arrangement cost”, “reduction in delay fee and damage compensation”, “reduction in shipping work cost”, and the like are stored as values of the “evaluation index”, and “2”, “2”, “1”, and the like are stored as values of the “weight coefficient” corresponding to the “evaluation index”. The value of the “evaluation index” corresponds to, for example, an attribute of the transportation resource, and various values may be stored.

The values in the “evaluation index” shown in FIG. 10 are an example. As another example, at least one of a cost reduction in an additional vehicle, a cost reduction in a canceled vehicle, a cost reduction in an operation time of the vehicle, a cost reduction in a transportation time of the driver, a cost reduction due to an assigned area of the driver, a cost reduction in an order loading work, a cost reduction in an order alignment work, a cost reduction in a loading work time of the shipping worker, a cost reduction in an alignment work time of the shipping worker, and the like may be stored.

The delay fee is a fee generated when the transportation is delayed, and the damage compensation is compensation that is generated for damage caused by the transportation. The delay fee and the damage compensation may be calculated based on the driver information 112b and the shipping worker information 112c. The storage unit 110 may store delay fee information indicating a condition under which the delay fee is generated, an amount of money, and the like, and damage compensation information indicating a condition under which the damage compensation is generated, an amount of money, and the like. These pieces of information may be included in any of the pieces of information shown in FIG. 1, or may be stored by the storage unit 110 independently of the pieces of information. These pieces of information are also used as a basis of the calculation of the distribution cost.

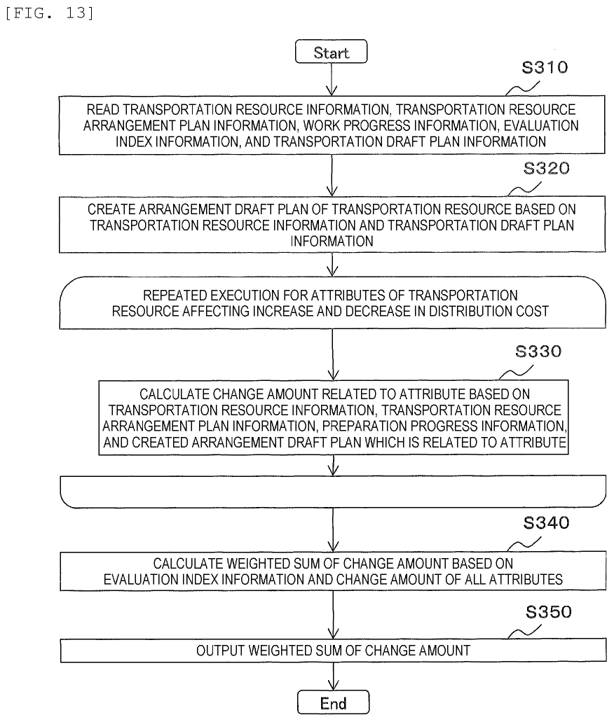

FIG. 11 is a diagram showing an example of a data structure of the transportation progress information 211 according to the first embodiment.

The transportation progress information 211 includes at least a “next transportation startable date and time” indicating a date and time at which the transportation vehicle can be used after the end of the transportation in progress.

In step S200 in FIG. 3, the draft plan creation unit 121 uses the transportation amount information 111, the transportation resource information 112, the base information 113, and the movement cost information 114 to create the plurality of transportation draft plans for transporting the packages using only available transportation resources, and stores the transportation plans in the transportation draft plan information 118. The transportation draft plan is created by, for example, all ways of search.

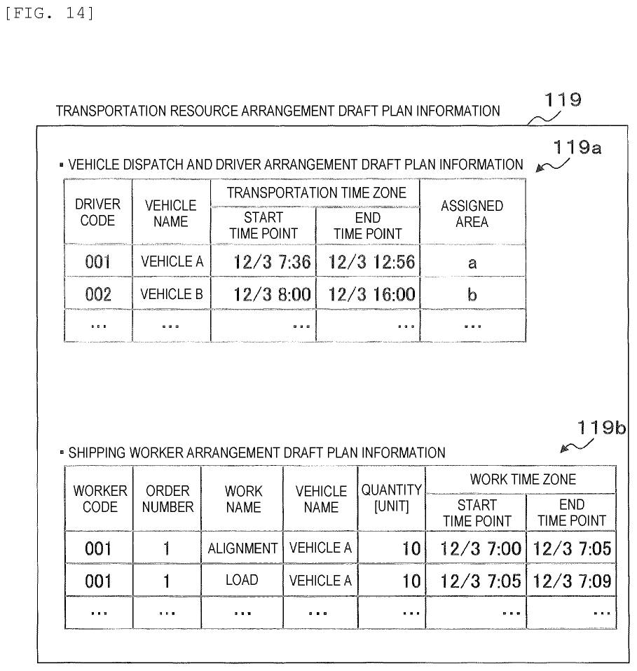

FIG. 12 is a diagram showing an example of a data structure of the transportation draft plan information 118 according to the first embodiment.

The transportation draft plan information 118 includes at least the plurality of transportation draft plans. Each transportation draft plan includes at least a “vehicle name” for identifying a vehicle, a “base name” for identifying a base of a transportation destination, a “work name” indicating a work performed at the base, an “order number” indicating an order of the work target, and a “work time” indicating a time for performing the work. The transportation draft plan information 118 may further include a “quantity” indicating a transportation amount of the order, a “weight” indicating a total weight, or a “volume” including a total volume. A “work time” may be substituted by a “work time zone” indicating a time zone during which the work is performed.

Description will be made by referring to FIG. 3 again. In step S300, the plan change amount calculation unit 122 calculates the plan change amount from the transportation plan for the regular service to the transportation draft plan using the transportation resource information 112, the transportation resource arrangement plan information 115, the preparation progress information 116, and one of the transportation draft plans created in step S200. When the change amount evaluation index information 117 is read in step S100, the change amount evaluation index information 117 may be used.

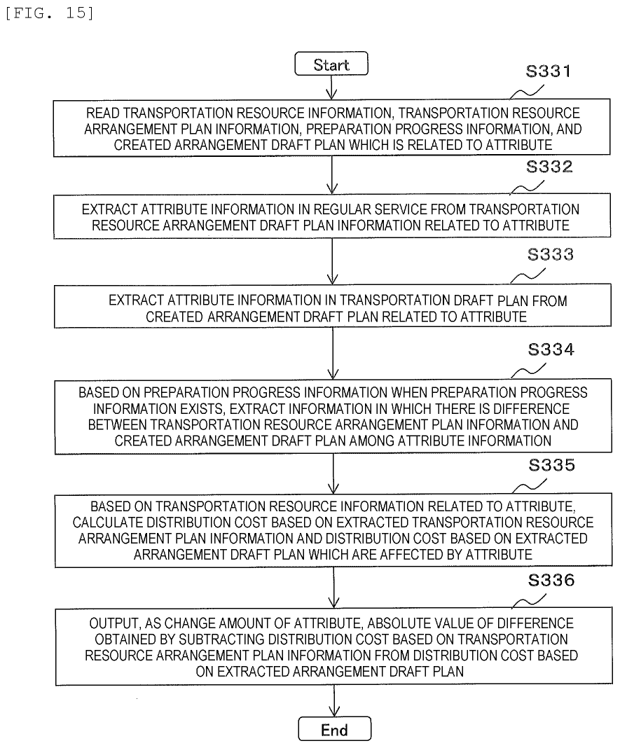

FIG. 13 is a flowchart showing an example of the plan change amount calculation processing using the change amount evaluation index information 117, which is performed by the plan change amount calculation unit 122 according to the first embodiment.

When the processing is started, the plan change amount calculation unit 122 reads the transportation resource information 112, the transportation resource arrangement plan information 115, the preparation progress information 116, and the change amount evaluation index information 117 from the storage unit 110, and reads the transportation draft plan information 118 (S310).

In step S320, the plan change amount calculation unit 122 creates an arrangement draft plan of the transportation resource based on the transportation resource information 112 and the transportation draft plan information 118 read in step S310, and stores the arrangement plan in the transportation resource arrangement draft plan information 119.

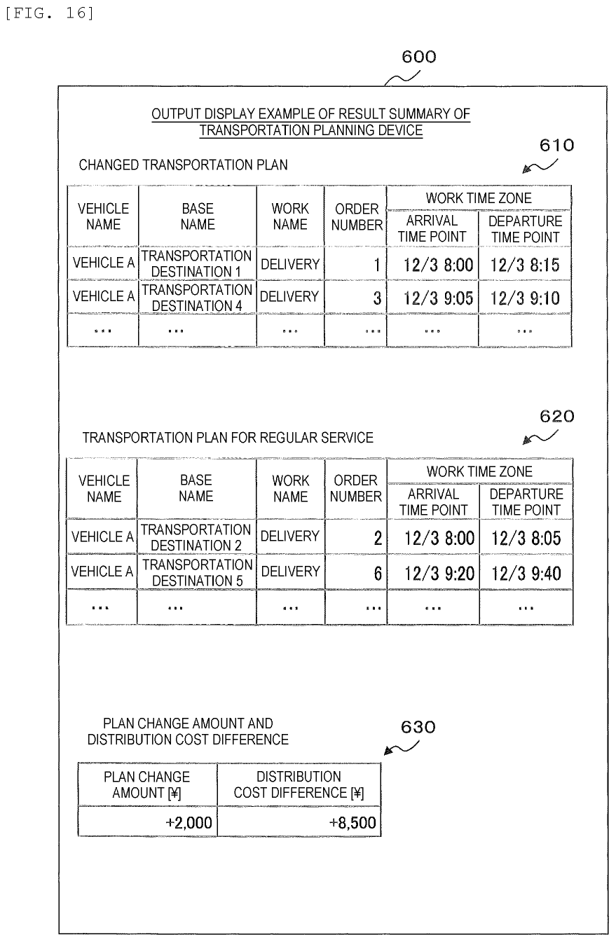

FIG. 14 is a diagram showing an example of a data structure of the transportation resource arrangement draft plan information 119 according to the first embodiment.

The transportation resource arrangement draft plan information 119 includes at least vehicle dispatch and driver arrangement draft plan information 119a and shipping worker arrangement draft plan information 119b. The vehicle dispatch and driver arrangement draft plan information 119a has the same data structure as the regular service vehicle dispatch and driver arrangement plan information 115a, and a content thereof is information on an arrangement plan of the vehicle and the driver based on the transportation resource arrangement draft plan. The shipping worker arrangement plan information 119b has the same data structure as the regular service shipping worker arrangement draft plan information 115b, and a content thereof is information on an arrangement plan of the shipping worker based on the transportation resource arrangement draft plan.

Description will be made by referring to FIG. 13 again. The plan change amount calculation unit 122 performs step S330 for all attributes of the transportation resource that affect increase and decrease in the distribution cost. Here, the attributes of the transportation resource that affect the increase or decrease in the distribution cost are, for example, an added vehicle, a canceled vehicle, an operation time of the vehicle, an operation time of the driver, an assigned area of the driver, an order loading vehicle, an order alignment vehicle, a loading work time of the shipping worker, or an alignment work time of the shipping worker.

In step S330, the plan change amount calculation unit 122 calculates the change amount of the attribute based on the transportation resource information 112, the transportation resource arrangement plan information 115, the preparation progress information 116, and the transportation resource arrangement plan draft information 119 which is related to the attribute.

FIG. 15 is a flowchart showing an example of the change amount calculation processing of the attribute of the transportation resource performed by the plan change amount calculation unit 122 according to the first embodiment.

When the processing is started, the plan change amount calculation unit 122 reads information related to the attribute in the transportation resource information 112, information related to the attribute in the transportation resource arrangement plan information 115, information related to the attribute in the preparation progress information 116, and information related to the attribute in the transportation resource arrangement draft plan information 119 (S331).

Next, the plan change amount calculation unit 122 extracts attribute information in the regular service from the information related to the attribute in the transportation resource arrangement plan information 115 (S332).

Next, the plan change amount calculation unit 122 extracts attribute information in the transportation draft plan from the attribute information in the transportation resource arrangement draft plan (S333).

Next, the plan change amount calculation unit 122 extracts information in which there is a difference between the attribute information in the transportation resource arrangement plan information for the regular service and the attribute information in the transportation resource arrangement draft plan (S334). At this time, when the preparation progress information 116 is read in step S331, the plan change amount calculation unit 122 determines whether there is a difference based on the preparation progress information 116.

Next, the plan change amount calculation unit 122 calculates, for the regular service and the transportation draft plan, the distribution cost, which is affected by the attribute, based on the information related to the attribute in the transportation resource information 112 (S335). Specifically, based on the information related to the attribute in the transportation resource information 112 and the regular service plan information extracted in step S334, the distribution cost to be changed among the distribution costs for the regular service related to the attribute is calculated. In addition, based on the information related to the attribute in the transportation resource information 112 and the arrangement draft plan extracted in step S334, a distribution cost to be varied among the distribution costs of the transportation draft plan related to the attribute is calculated.

Finally, the plan change amount calculation unit 122 outputs, as the change amount of the attribute, an absolute value of a difference which is obtained by subtracting the distribution cost for the regular service from the distribution cost of the transportation draft plan and which is extracted in step S335 (S336).

Two specific examples of the change amount calculation processing of the attribute of the transportation resource will be described with reference to FIGS. 8 and 14.

In change amount calculation processing of the transportation time of the driver, in step S331, the plan change amount calculation unit 122 reads the driver information 112b, the regular service vehicle dispatch and driver arrangement plan information 115a, and the vehicle dispatch and driver arrangement draft plan information 119a. In step S332, the plan change amount calculation unit 122 extracts, from the regular service vehicle dispatch and driver arrangement plan information 115a, information obtained by combining the driver code and the transportation time zone. In step S333, the plan change amount calculation unit 122 extracts information similar to that in step S332 from the vehicle dispatch and driver arrangement draft plan information 119a.

Next, in step S334, the plan change amount calculation unit 122 extracts information in which there is a difference in the transportation time of the driver. For example, the transportation time of a driver identified by a value of a driver code “001” (hereinafter, also simply referred to as “driver code 001”) is 30 minutes in the regular service vehicle dispatch and driver arrangement plan information 115a, but is 50 minutes in the vehicle dispatch and driver arrangement draft plan information 119a. In this case, the plan change amount calculation unit 122 determines that there is the difference in the transportation time, and extracts these pieces of information. Next, in step S335, the plan change amount calculation unit 122 calculates the labor cost of the driver based on the labor cost of the driver information 112b and the extracted difference information. For example, the labor costs of the driver code 001 in the regular service and the transportation draft plan can be calculated as in the following formulas (1) and (2), respectively.

$$\begin{matrix}\begin{matrix}\begin{matrix}LABOR COST OF DRIVER CODE 001 \\ IN REGULAR SERVICE\end{matrix} = 1200 \times 30 \\ = 36000\end{matrix} & [ Formula 1 ] \\ \begin{matrix} \begin{matrix}LABOR COST OF DRIVER CODE 001 \\ IN TRANSPORTATION DRAFT PLAN\end{matrix} = 1200 \times 50 \\ = 60000\end{matrix} & [ Formula 2 ]\end{matrix}$$

Finally, in step S336, the plan change amount calculation unit 122 outputs a change amount of the labor cost of the driver as the change amount of the transportation time of the driver. For example, the change amount in the labor cost of the driver can be calculated by a sum of change amounts in the labor cost of the drivers. A change amount in the labor cost of the driver code 001 can be calculated as in the following formula (3).

$$\begin{matrix} \begin{matrix}CHANGE AMOUNT IN LABOR \\ COST OF DRIVER CODE 001\end{matrix} = \vert 60000 - 36000 \vert \\ = 24000\end{matrix} \qquad [ Formula 3 ]$$

In change amount calculation processing of the alignment work time of the shipping worker, in step S331, the plan change amount calculation unit 122 reads the shipping worker information 112c, the regular service shipping worker arrangement plan information 115b, the shipping worker arrangement draft plan information 119b, and the preparation progress information 116. In step S332, the plan change amount calculation unit 122 extracts, from the regular service shipping worker arrangement plan information 115b, information obtained by combining the worker code, the order number, the vehicle name, and the work time zone in a row in which the work name is alignment. In step S333, the plan change amount calculation unit 122 extracts information similar to that in step S332 from the shipping worker arrangement draft plan information 119b.

Next, in step S334, the plan change amount calculation unit 122 extracts information in which there is a difference in the alignment work time of the shipping worker. For example, the alignment work of an order number 1 performed by a shipping worker identified by a value of a worker code “001” (hereinafter, also simply referred to as “worker code 001”) is performed for a vehicle B in the regular service shipping worker arrangement plan information 115b, but is performed for a vehicle A in the shipping worker arrangement draft plan information 119b. In the preparation progress information 116, the alignment work with the order number 1 has been performed. Therefore, when a target of the alignment work with the order number 1 is changed from the vehicle B to the vehicle A, it is understood that an alignment change work is necessary. In this case, the plan change amount calculation unit 122 determines that there is a difference in the alignment work time, and extracts these pieces of information. Next, in step S335, the plan change amount calculation unit 122 calculates a change amount of the labor cost related to the alignment change work of the shipping worker based on the labor cost of the shipping worker information 112c and the extracted difference information. For example, labor costs of the worker code 001 in the regular service and the transportation draft plan can be calculated as in the following formulas (4) and (5), respectively.

$$\begin{matrix}\begin{matrix}\begin{matrix}LABOR COST OF WORKER CODE 001 \\ IN REGULAR SERVICE\end{matrix} = 1000 \times 5 \\ = 5000\end{matrix} & [ Formula 4 ] \\ \begin{matrix}\begin{matrix}LABOR COST OF WORKER CODE 001 \\ IN TRANSPORTATION DRAFT PLAN\end{matrix} = 1000 \times ( 5 \times 2 ) \\ = 10000\end{matrix} & [ Formula 5 ]\end{matrix}$$

Finally, in step S336, the plan change amount calculation unit 122 outputs the change amount of the labor cost of the shipping worker as the change amount of the alignment change time of the shipping worker. For example, a change amount in the labor cost of the shipping worker can be calculated by a sum of change amounts in the labor cost of the shipping workers. A change amount in the labor cost of the worker code 001 can be calculated as in the following formula (6).

$$\begin{matrix}\begin{matrix}LABOR COST REQUIRED FOR \\ ALIGNMENT CHANGE WORK \\ OF WORKER CODE 001\end{matrix} = \vert 10000 - 5000 \vert \\ = 5000\end{matrix} \qquad [ Formula 6 ]$$

Description will be made by referring to FIG. 13 again. When the plan change amount calculation unit 122 completes the calculation of the change amount of each attribute in this manner, the plan change amount calculation unit 122 then calculates a weighted sum of the change amount as in the following formula (7) based on the change amount evaluation index information 117 and the change amounts of all attributes (S340).

$$\begin{matrix}WEIGHTED SUM OF \\ CHANGE AMOUNT\end{matrix} = {\sum }_{ATTRIBUTE} ( \begin{matrix}WEIGHTED COEFFICIENT OF \\ EVALUATION INDEX \\ AFFECTED BY ATTRIBUTE \times \\ CHANGE AMOUNT OF ATTRIBUTE\end{matrix} ) \qquad [ Formula 7 ]$$

Finally, the plan change amount calculation unit 122 outputs the weighted sum of the change amounts as the plan change amount (S350).

In the plan change amount calculation processing, when the change amount evaluation index information 117 is not used, the plan change amount calculation unit 122 does not read the change amount evaluation index information 117 in step S310, calculates the sum of the change amounts in step S340, and outputs the sum of the change amounts in step S350.

Description will be made by referring to FIG. 3 again. In step S400, the change amount evaluation unit 123 determines whether the plan change amount calculated in the immediately preceding step S300 is smaller than the change amount of the provisional transportation plan.

In step S500, the change amount evaluation unit 123 stores the transportation draft plan for which the plan change amount is calculated in the immediately preceding step S300 as the provisional transportation plan.

In step S600, the display unit 140 receives the information on the changed transportation plan stored in the change amount evaluation unit 123, and displays the information on the display device 450. The communication unit 150 transmits information on the changed transportation plan to the in-vehicle terminal 200 and the shipping plan management terminal 300 via the network N.

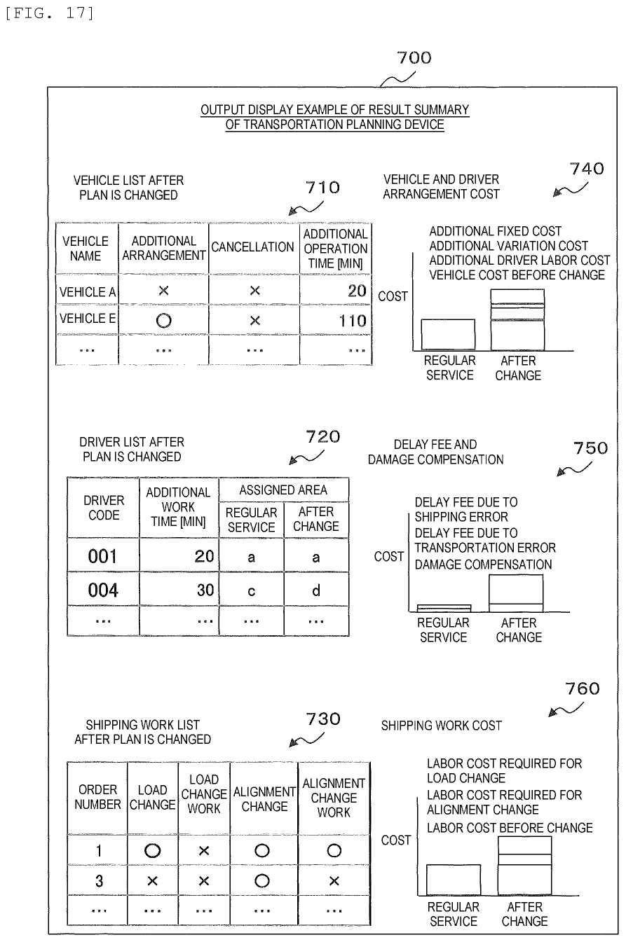

FIG. 16 is a diagram showing an example of a display screen 600 of a result summary displayed on the display device 450 of the transportation planning device 100 according to the first embodiment.

The display screen 600 includes a display area 610 of the changed transportation plan, a display area 620 of the transportation plan for the regular service, and a display area 630 of the plan change amount and the distribution cost difference. With the display screen 600, it is possible to acquire the changed transportation plan, compare the transportation plans before and after the change, confirm the distribution cost required for the plan change, and confirm the plan change amount converted into the distribution cost.

In the display area 610 of the changed transportation plan, a transportation draft plan having a smallest change amount is displayed. Specifically, a transportation vehicle, an order transported by the transportation vehicle, a transportation destination base name, a work name performed at the base, and a work time zone are displayed. Further, a transportation amount of the order may be displayed. The transportation amount may be substituted by a quantity, a weight, a volume, or a combination thereof. The work time zone may be substituted by a time during which the work is performed or a time zone during which the vehicle stays at the base. The transportation plan may be visualized as a Gantt chart (not shown) in which a horizontal axis is time and a vertical axis is each vehicle.

The transportation plan for the regular service is displayed in the display area 620 of the transportation plan for the regular service. Specific display items are the same as those in the display area 610 of the changed transportation plan.

In the display area 630 of the plan change amount and the distribution cost difference, the plan change amount converted into the distribution cost and an additional distribution cost generated by the plan change are displayed. The plan change amount converted into the distribution cost is, for example, a value obtained by performing calculation as shown in formulas (1) to (7) between the transportation draft plan displayed in the display area 610 of the changed transportation plan and the transportation plan for the regular service. The additional distribution cost generated by the plan change is, for example, an increase to the distribution cost based on the transportation draft plan displayed in the display area 610 of the changed transportation plan from the distribution cost based on the transportation plan for the regular service, and is calculated by subtracting a sum of the former distribution costs from a sum of the latter distribution costs.

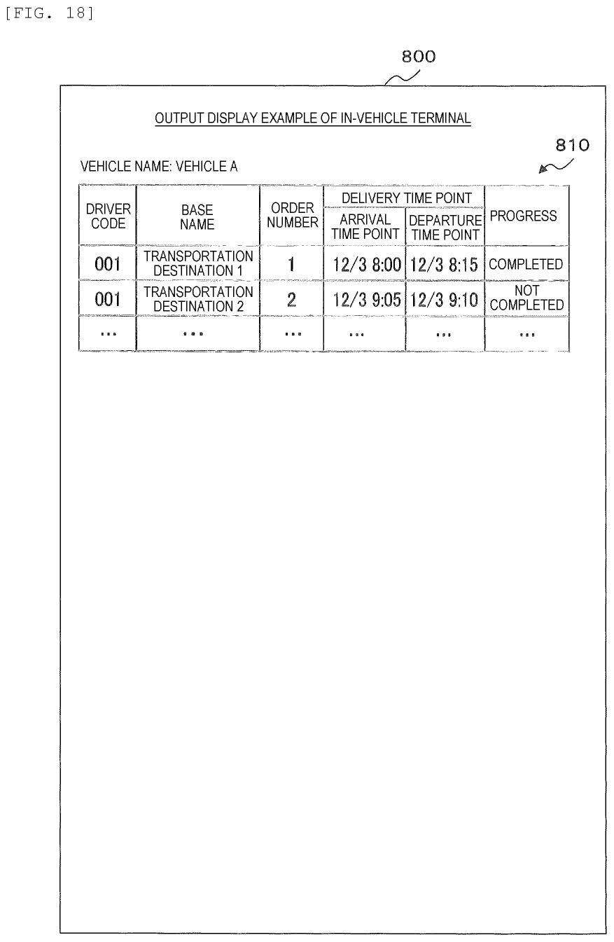

FIG. 17 is a diagram showing an example of a change amount display screen 700 displayed on the display device 450 of the transportation planning device 100 according to the first embodiment.

The display screen 700 includes a display area 710 of a vehicle list after the plan is changed, a display area 720 of a driver list after the plan is changed, a display area 730 of a shipping work list after the plan is changed, a display area 740 of a vehicle and driver arrangement cost, a display area 750 of a delay fee and damage compensation, and a display area 760 of a shipping work cost. With the display screen 700, a changed portion of the plan and a change amount of a breakdown of the distribution cost can be confirmed, and analysis and plan correction are facilitated.

In the display area 710 of the vehicle list after the plan is changed, different vehicle information between the transportation plan for the regular service and the changed transportation plan is displayed. Specifically, a vehicle name used for transportation, a flag indicating presence or absence of additional arrangement of a vehicle, a flag indicating presence or absence of cancellation of arrangement of the vehicle, and an additional operation time of the vehicle are displayed.

In the display area 720 of the driver list after the plan is changed, different driver information between the transportation plan for the regular service and the changed transportation plan is displayed. Specifically, a driver code for performing a transportation work, an additional work time of the driver, and assigned areas of the driver in plan for regular service and the changed plan are displayed.

In the display area 730 of the shipping work list after the plan is changed, different shipping work information between the transportation plan for the regular service and the changed transportation plan is displayed. Specifically, an order number indicating a work target, a flag indicating presence or absence of a change in a vehicle on which the order is loaded, a flag indicating presence or absence of necessity of an additional work for changing the loading, a flag indicating presence or absence of an alignment change of the order, and a flag indicating presence or absence of necessity of an additional work due to the alignment change are displayed.

In the display area 740 of the vehicle and driver arrangement cost, costs required for arrangement of the vehicle and driver in the transportation plan for the regular service and the changed transportation plan are displayed.

In the display area 750 of the delay fee and the damage compensation, the delay fee and the damage compensation in each of the transportation plan for the regular service and the changed transportation plan is displayed.

In the display area 760 of the shipping work cost, labor costs required for the shipping work in the transportation plan for the regular service and the changed transportation plan are displayed.

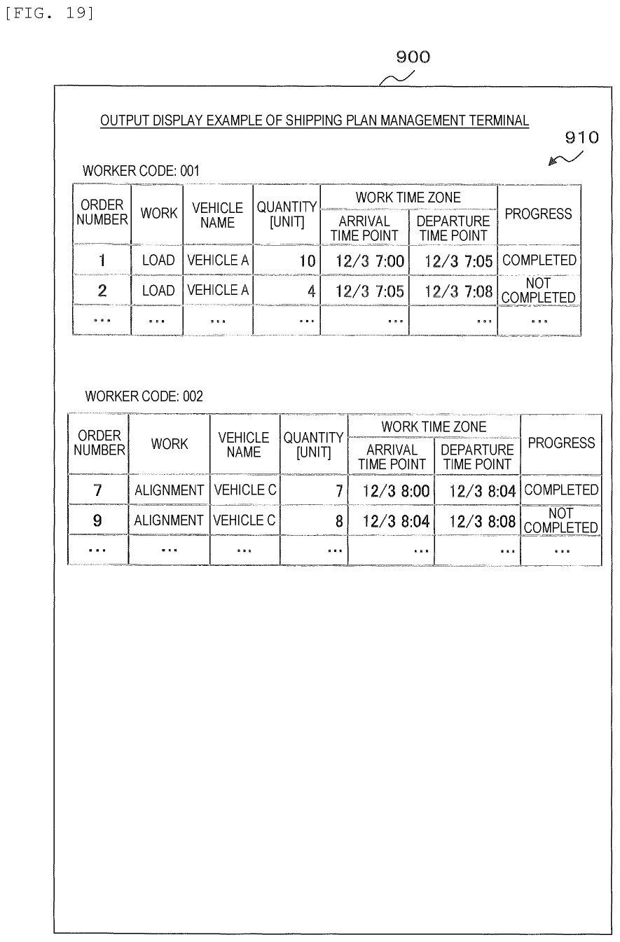

FIG. 18 is a diagram showing an example of a display screen 800 of the in-vehicle terminal 200 according to the first embodiment.

The display screen 800 includes a transportation plan display area 810. In the transportation plan display area 810, the changed transportation plan of the vehicle 510 is displayed. Specifically, in addition to display items the same as the display items in the display area 610 of the changed transportation plan, information indicating a progress status of the transportation work of the package (for example, whether the transportation work is completed) is displayed. With the display screen 800, it is possible to confirm the changed transportation plan and the progress status according to the driver.

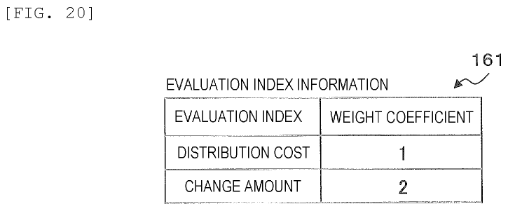

FIG. 19 is a diagram showing an example of a display screen 900 of the shipping plan management terminal 300 according to the first embodiment.

The display screen 900 includes a work plan display area 910 for each worker. In the work plan display area 910, information on work performed by the worker is displayed. Specifically, for each worker, an order number indicating a work target, a vehicle name on which the order is loaded, a work name performed by the worker, a work time zone, and a progress status of the work (for example, whether the work is completed) are displayed. Further, a transportation amount of the order may be displayed. The transportation amount may be substituted by a quantity, a weight, a volume, or a combination thereof. The work time zone may be substituted by a time during which the work is performed. With the display screen 900, the changed shipping plan according to a loading worker can be confirmed.

### Second Embodiment

In the present embodiment, the change amount evaluation unit 123 evaluates a weighted sum of a plan change amount and a distribution cost. Except for the differences to be described below, each unit of the system of the second embodiment has the same function as that of each unit denoted by the same reference numerals of the first embodiment shown in FIGS. 1 to 19, so that the description thereof will be omitted.

Storage unit 110: In addition to the information stored in the storage unit 110 according to the first embodiment, evaluation index information 161 for the distribution cost and the change amount is stored.

FIG. 20 is a diagram showing an example of a data structure of the evaluation index information 161 according to the second embodiment.

The evaluation index information 161 includes at least an “evaluation index” that is an evaluation index of a plan and a “weight coefficient” that indicates a weight coefficient of each evaluation index in evaluation function calculation.

In the example of FIG. 20, a “distribution cost” and a “change amount” are stored as values of the “evaluation index”, and “1” and “2” are stored as values of the “weight coefficient” corresponding to the “distribution cost” and the “change amount”, respectively. This indicates that a weight of the distribution cost based on the transportation draft plan is “1” and a weight of the plan change amount from the transportation plan for the regular service to the transportation draft plan is “2”. These values are examples, and any value of the weight coefficient can be set, for example, by increasing one weight or reducing one weight. The first embodiment corresponds to a case where the weight coefficient of the “distribution cost” is set to “0” and the weight coefficient of the “change amount” is set to “1”.

Changes from the first embodiment to the second embodiment will be described again.

Step S100: The storage unit 110 reads the evaluation index information 161 from the input device 460 in addition to the information according to the first embodiment.

Step S300: The plan change amount calculation unit 122 uses the transportation resource information 112, the transportation resource arrangement plan information 115, the preparation progress information 116, the evaluation index information 161, and one of the transportation draft plans created in step S200 to calculate a weighted sum of the plan change amount from the transportation plan for the regular service to the transportation draft plan and the distribution cost. When the change amount evaluation index information 117 is read in step S100, the change amount evaluation index information 117 may be used.

Hereinafter, a change of the step when the change amount evaluation index information 117 is used will be described.

Step S310: The plan change amount calculation unit 122 reads the transportation resource information 112, the transportation resource arrangement plan information 115, the preparation progress information 116, the evaluation index information 161, and the change amount evaluation index information 117 from the storage unit 110, and reads the transportation draft plan information 118.

Step S330: The plan change amount calculation unit 122 calculates a change amount of the attribute and the distribution cost based on the transportation resource information 112, the transportation resource arrangement plan information 115, the preparation progress information 116, and the transportation resource arrangement draft plan information 119 which is related to the attribute.

Step S336: The plan change amount calculation unit 122 outputs, as the change amount of the attribute, an absolute value of a difference obtained by subtracting the distribution cost for the regular service from the distribution cost of the transportation draft plan extracted in S335, and outputs the distribution cost of the transportation draft plan.

Step S340: The plan change amount calculation unit 122 calculates the weighted sum of the change amount based on the change amount evaluation index information 117 and the change amounts of all the attributes. Then, the plan change amount calculation unit 122 calculates a weighted sum of the weighted sum of the change amount and the distribution cost of the transportation draft plan based on the evaluation index information 161, the weighted sum of the change amount, and the distribution cost of the transportation draft plan.

Step S350: The plan change amount calculation unit 122 outputs the weighted sum of the weighted sum of the change amount and the distribution cost of the transportation draft plan.

Step S400: The change amount evaluation unit 123 determines whether the weighted sum of the plan change amount and the distribution cost calculated in the immediately preceding step S300 is smaller than the change amount of the provisional transportation plan.

The transportation planning system according to the embodiments of the invention is described above. According to such a transportation planning system, it is possible to make a transportation plan for reducing the plan change amount or a transportation plan for reducing the plan change amount and the distribution cost in response to the variation in the transportation amount and the change in the transportation resource.

The system according to the embodiments of the invention may be constituted as follows.

(1) A transportation planning system (for example, the transportation planning device 100 or the transportation planning system 1 including the transportation planning device 100) includes a control unit (for example, the control unit 120) and a storage unit (for example, the storage unit 110). The storage unit stores transportation amount information (for example, the transportation amount information 111) indicating a transportation source, a transportation destination, and a transportation amount of an article based on an order, transportation resource information (for example, the transportation resource information 112) indicating a transportation resource available for transportation of the article, and transportation resource arrangement plan information (for example, the transportation resource arrangement plan information 115) indicating a preset transportation resource arrangement plan. The control unit generates, based on the transportation amount information and the transportation resource information, a plurality of transportation resource arrangement draft plans (for example, the arrangement draft plans included in the transportation resource arrangement draft plan information 119) for transportation of the article based on the order using the transportation resource available for the transportation of the article (for example, S200), and calculates, based on the transportation resource arrangement plan information, a change amount of a distribution cost when the transportation resource arrangement draft plan is adopted with respect to a distribution cost based on the preset transportation resource arrangement plan, for each of the plurality of transportation resource arrangement draft plans (for example, S300).

Accordingly, it is possible to make a transportation plan for reducing the plan change amount in response to the variation in the transportation amount and the change in the transportation resource.

(2) In the above (1), the storage unit stores a weight coefficient (for example, a weight coefficient in the change amount evaluation index information 117) of the change amount of the distribution cost for each attribute of the transportation resource, and the control unit calculates, for each attribute of the transportation resource, an absolute value of a difference between the distribution cost based on the preset transportation resource arrangement plan and the distribution cost when the transportation resource arrangement draft plan is adopted, and calculates, as the change amount of the distribution cost, a weighted sum of the absolute value of the difference using the weight coefficient (for example, S330 and S340).

Accordingly, it is possible to appropriately calculate the change amount.

(3) In the above (2), the transportation resource information includes vehicle information (for example, the vehicle information 112a) related to a vehicle available for transportation of the article, driver information (for example, the driver information 112b) related to a driver available for driving of the vehicle, and shipping worker information (for example, the shipping worker information 112c) related to a shipping worker available fora work of loading the article on the vehicle, and the attribute of the transportation resource includes at least one of a vehicle added to the preset transportation resource arrangement plan, a vehicle canceled from the preset transportation resource arrangement plan, an operation time of the vehicle, a transportation time of the driver, an assigned area of the driver, a loading work of the article based on the order, an alignment work of the article based on the order, a time of the loading work of the shipping worker, and a time of the alignment work of the shipping worker.

Accordingly, it is possible to appropriately calculate the change amount.

(4) In the above (1), the storage unit stores a weight coefficient of the change amount of the distribution cost and a weight coefficient of the distribution cost (for example, a weight coefficient of the evaluation index information 161), and the control unit calculates a weighted sum using the weight coefficient of the change amount of the distribution cost when the transportation resource arrangement draft plan is adopted with respect to the distribution cost based on the preset transportation resource arrangement plan and the weight coefficient of the distribution cost when the transportation resource arrangement draft plan is adopted (for example, S340), and specifies a transportation draft plan implemented by the transportation resource arrangement draft plan in which the weighted sum is minimum (for example, S600).

Accordingly, it is possible to make a transportation plan for reducing the plan change amount and the distribution cost in response to the variation in the transportation amount and the change in the transportation resource.

(5) In the above (4), the transportation resource information includes vehicle information related to a vehicle available for transportation of the article, driver information related to a driver available for driving of the vehicle, and shipping worker information related to a shipping worker available for a work of loading the article on the vehicle, the transportation resource arrangement draft plan includes information (for example, the vehicle dispatch and driver arrangement draft plan information 119a and the shipping worker arrangement draft plan information 119b) on the vehicle, the driver, and the shipping worker used for the transportation of the article based on the order, and the control unit transmits the transportation resource arrangement draft plan and the transportation draft plan to an in-vehicle terminal (for example, the in-vehicle terminal 200) of the vehicle included in the transportation draft plan implemented by the transportation resource arrangement draft plan in which the weighted sum is minimum and a management terminal (for example, the shipping plan management terminal 300) for managing the shipping work of the shipping worker included in the transportation resource arrangement draft plan (for example, S600).

Accordingly, the generated transportation resource arrangement draft plan is appropriately transmitted to a target on which the arrangement draft plan is executed.

(6) In the above (5), the system further includes a display unit (for example, the display unit 140) connected to the control unit, and the in-vehicle terminal (for example, the in-vehicle terminal 200) and the management terminal (for example, the shipping plan management terminal 300) connected to the control unit via a network (for example, the network N), the display unit displays at least one of the transportation resource arrangement draft plan in which the weighted sum is minimum, the preset transportation resource arrangement plan, the change amount of the distribution cost, the distribution cost, the distribution cost for each transportation resource when each of the transportation resource arrangement draft plan in which the weighted sum is minimum and the preset transportation resource arrangement plan is adopted, and a transportation draft plan implemented by the transportation resource arrangement draft plan in which the weighted sum is minimum (for example, any one of the displays in FIGS. 16 and 17), the in-vehicle terminal outputs a transportation draft plan related to the vehicle on which the in-vehicle terminal is mounted among the transportation draft plan in which the weighted sum is minimum (for example, the output in FIG. 18), and the management terminal outputs an arrangement draft plan related to a management target of the management terminal among the transportation resource arrangement draft plan in which the weighted sum is minimum (for example, the output in FIG. 19).

Accordingly, confirmation of validity of the generated arrangement draft plan is supported, and the generated arrangement draft plan is appropriately transmitted to a target on which the arrangement draft plan is executed.

(7) In the above (1), the transportation resource information includes vehicle information related to a vehicle available for transportation of the article, driver information related to a driver available for driving of the vehicle, and shipping worker information related to a shipping worker available for a work of loading the article on the vehicle, the transportation resource arrangement draft plan includes information on the vehicle, the driver, and the shipping worker used for the transportation of the article based on the order, the storage unit further stores at least one of base information (for example, the base information 113) indicating an area to which a base of the transportation of the article belongs, movement cost information (for example, the movement cost information 114) indicating a movement time from a transportation source to a transportation destination of the article, preparation progress information (for example, the preparation progress information 116) indicating a progress status of a work based on the transportation resource arrangement plan, unit price information for each of the vehicle, a cancellation fee for each of the vehicle, unit price information for each of the driver, assigned area information for each of the driver, a transportation error risk coefficient indicating a magnitude of a risk of a transportation error for each of the driver, unit price information for each of the shipping worker, a shipping error risk coefficient indicating a magnitude of a risk of a shipping error for each of the shipping worker, delay fee information indicating delay fee generated when the transportation is delayed, and damage compensation information indicating damage compensation generated for damage caused by the transportation (for example, at least one of FIGS. 5 to 7, FIGS. 9 to 11, and FIG. 20), and the control unit generates, based on at least one of the transportation amount information, the transportation resource information, the base information, the movement cost information, and the preparation progress information, a plurality of transportation draft plans for the article based on the order using the transportation resource available for the transportation of the article, generates a transportation resource arrangement draft plan for implementing the transportation for each of the transportation draft plans, and calculates, based on at least one of the transportation resource arrangement plan information, the unit price information for each of the vehicle, the cancellation fee, the unit price information for each of the driver, the assigned area information, the transportation error risk coefficient, the unit price information for each of the shipping worker, the shipping error risk coefficient, the delay fee information, and the damage compensation information, a change amount of a distribution cost when the transportation resource arrangement draft plan is adopted with respect to the distribution cost based on the preset transportation resource arrangement plan, for each of the plurality of transportation resource arrangement draft plans.

Accordingly, the distribution cost can be appropriately calculated.

The invention is not limited to the above embodiments, and includes various modifications. For example, the embodiments described above have been described in detail for better understanding of the invention, and are not necessarily limited to the embodiments that include all the configurations described above. A part of configurations of a certain embodiment can be replaced with configurations of another embodiment. Alternatively, configurations of a certain embodiment can be added to configurations of another embodiment. Apart of the configuration of each embodiment may be subjected to addition, deletion and replacement of another configuration.

Configurations, functions, processing units, processing methods and the like described above may be partially or entirely implemented by hardware such as through design using an integrated circuit. The configurations, functions, and the like may also be implemented by software by means of a processor interpreting and executing a program for implementing respective functions. Information such as a program, a table, or a file for implementing each function can be stored in a storage device such as a nonvolatile semiconductor memory, a Hard Disk Drive, and a solid state drive (SSD), or a computer readable non-transitory data storage medium such as an IC card, an SD card, and a DVD.

Further, control lines and information lines show those considered to be necessary for description, and not all of the control lines and the information lines are necessarily shown in a product. In practice, it may be considered that almost all of the configurations are connected to one another.

### REFERENCE SIGN LIST

1 transportation planning system
100 transportation planning device
110 storage unit
111 transportation amount information
112 transportation resource information
113 base information
114 movement cost information
115 transportation resource arrangement plan information
116 preparation progress information
117 change amount evaluation index information
118 transportation draft plan information
119 transportation resource arrangement draft plan information
120 control unit
121 draft plan creation unit
122 plan change amount calculation unit
123 change amount evaluation unit
130 input unit
140 display unit
150 communication unit
N network
200 in-vehicle terminal
210 storage unit
211 transportation progress information
300 shipping plan management terminal
310 storage unit
311 progress information

1. A transportation planning system comprising:
a control unit; and
a storage unit connected to the control unit, wherein
the storage unit stores transportation amount information indicating a transportation source, a transportation destination, and a transportation amount of an article based on an order, transportation resource information indicating a transportation resource available for transportation of the article, and transportation resource arrangement plan information indicating a preset transportation resource arrangement plan, and
the control unit is configured to:
generate, based on the transportation amount information and the transportation resource information, a plurality of transportation resource draft plans of the article based on the order using the transportation resource available for the transportation of the article, and generate, for each of the transportation draft plans, a transportation resource arrangement draft plan for implementing the transportation, and
calculate, based on the transportation resource arrangement plan information, a change amount of a distribution cost when the transportation resource arrangement draft plan is adopted with respect to a distribution cost based on the preset transportation resource arrangement plan, for each of the plurality of transportation resource arrangement draft plans.

2. The transportation planning system according to claim 1, wherein
the storage unit stores a weight coefficient of the change amount of the distribution cost for each attribute of the transportation resource, and
the control unit calculates, for each attribute of the transportation resource, an absolute value of a difference between the distribution cost based on the preset transportation resource arrangement plan and the distribution cost when the transportation resource arrangement draft plan is adopted, and calculates, as the change amount of the distribution cost, a weighted sum of the absolute value of the difference using the weight coefficient.

3. The transportation planning system according to claim 2, wherein
the transportation resource information includes vehicle information related to a vehicle available for transportation of the article, driver information related to a driver available for driving of the vehicle, and shipping worker information related to a shipping worker available for a work of loading the article on the vehicle, and
the attribute of the transportation resource includes at least one of the vehicle added to the preset transportation resource arrangement plan, the vehicle canceled from the preset transportation resource arrangement plan, an operation time of the vehicle, a transportation time of the driver, an assigned area of the driver, a loading work of the article based on the order, an alignment work of the article based on the order, a time of the loading work of the shipping worker, and a time of the alignment work of the shipping worker.

4. The transportation planning system according to claim 1, wherein
the storage unit stores a weight coefficient of the change amount of the distribution cost and a weight coefficient of the distribution cost, and
the control unit calculates a weighted sum using the weight coefficient of the change amount of the distribution cost when the transportation resource arrangement draft plan is adopted with respect to the distribution cost based on the preset transportation resource arrangement plan and the weight coefficient of the distribution cost when the transportation resource arrangement draft plan is adopted, and specifies a transportation draft plan implemented by the transportation resource arrangement draft plan in which the weighted sum is minimum.

5. The transportation planning system according to claim 4, wherein
the transportation resource information includes vehicle information related to a vehicle available for transportation of the article, driver information related to a driver available for driving of the vehicle, and shipping worker information related to a shipping worker available for a work of loading the article on the vehicle,
the transportation resource arrangement draft plan includes information on the vehicle, the driver, and the shipping worker used for the transportation of the article based on the order, and
the control unit transmits the transportation resource arrangement draft plan and the transportation draft plan to an in-vehicle terminal of the vehicle included in the transportation draft plan implemented by the transportation resource arrangement draft plan in which the weighted sum is minimum and a management terminal for managing the shipping work of the shipping worker included in the transportation resource arrangement draft plan.

6. The transportation planning system according to claim 5, further comprising:
a display unit connected to the control unit, and the in-vehicle terminal and the management terminal connected to the control unit via a network, wherein
the display unit displays at least one of the transportation resource arrangement draft plan in which the weighted sum is minimum, the preset transportation resource arrangement plan, the change amount of the distribution cost, the distribution cost, the distribution cost for each transportation resource when each of the transportation resource arrangement draft plan in which the weighted sum is minimum and the preset transportation resource arrangement plan is adopted, and a transportation draft plan implemented by the transportation resource arrangement draft plan in which the weighted sum is minimum,
the in-vehicle terminal outputs a transportation draft plan related to the vehicle on which the in-vehicle terminal is mounted among the transportation draft plan in which the weighted sum is minimum, and
the management terminal outputs an arrangement draft plan related to a management target of the management terminal among the transportation resource arrangement draft plan in which the weighted sum is minimum.

7. The transportation planning system according to claim 1,
wherein
the transportation resource information includes vehicle information related to a vehicle available for transportation of the article, driver information related to a driver available for driving of the vehicle, and shipping worker information related to a shipping worker available for a work of loading the article on the vehicle,
the transportation resource arrangement draft plan includes information on the vehicle, the driver, and the shipping worker used for the transportation of the article based on the order,
the storage unit further stores at least one of base information indicating an area to which abase of the transportation of the article belongs, movement cost information indicating a movement time from a transportation source to a transportation destination of the article, preparation progress information indicating a progress status of a work based on the transportation resource arrangement plan, unit price information for each of the vehicle, a cancellation fee for each of the vehicle, unit price information for each of the driver, assigned area information for each of the driver, a transportation error risk coefficient indicating a magnitude of a risk of a transportation error for each of the driver, unit price information for each of the shipping worker, a shipping error risk coefficient indicating a magnitude of a risk of a shipping error for each of the shipping worker, delay fee information indicating delay fee generated when the transportation is delayed, and damage compensation information indicating damage compensation generated for damage caused by the transportation, and
the control unit is configured to:
generate, based on at least one of the transportation amount information, the transportation resource information, the base information, the movement cost information, and the preparation progress information, a plurality of transportation draft plans for the article based on the order using the transportation resource available for the transportation of the article, and generate, for each of the transportation draft plans, a transportation resource arrangement draft plan for implementing the transportation, and
calculate, based on at least one of the transportation resource arrangement plan information, the unit price information for each of the vehicle, the cancellation fee, the unit price information for each of the driver, the assigned area information, the transportation error risk coefficient, the unit price information for each of the shipping worker, the shipping error risk coefficient, the delay fee information, and the damage compensation information, a change amount of a distribution cost when the transportation resource arrangement draft plan is adopted with respect to the distribution cost based on the preset transportation resource arrangement plan, for each of the plurality of transportation resource arrangement draft plans.

8. A transportation planning method executed by a transportation planning system including a control unit and a storage unit connected to the control unit, in which
the storage unit stores transportation amount information indicating a transportation source, a transportation destination, and a transportation amount of an article based on an order, transportation resource information indicating a transportation resource available for transportation of the article, and transportation resource arrangement plan information indicating a preset transportation resource arrangement plan,
the transportation planning method comprising:
a first step of the control unit generating, based on the transportation amount information and the transportation resource information, a plurality of transportation resource draft plans of the article based on the order using the transportation resource available for the transportation of the article, and generating, for each of the transportation draft plans, a transportation resource arrangement draft plan for implementing the transportation; and
a second step of, the control unit calculating, based on the transportation resource arrangement plan information, a change amount of a distribution cost when the transportation resource arrangement draft plan is adopted with respect to a distribution cost based on the preset transportation resource arrangement plan, for each of the plurality of transportation resource arrangement draft plans.

9. The transportation planning method according to claim 8, wherein
the storage unit stores a weight coefficient of the change amount of the distribution cost for each attribute of the transportation resource, and
in the second step, the control unit calculates, for each attribute of the transportation resource, an absolute value of a difference between the distribution cost based on the preset transportation resource arrangement plan and the distribution cost when the transportation resource arrangement draft plan is adopted, and calculates, as the change amount of the distribution cost, a weighted sum of the absolute value of the difference using the weight coefficient.

10. The transportation planning method according to claim 9, wherein
the transportation resource information includes vehicle information related to a vehicle available for transportation of the article, driver information related to a driver available for driving of the vehicle, and shipping worker information related to a shipping worker available for a work of loading the article on the vehicle, and
the attribute of the transportation resource includes at least one of the vehicle added to the preset transportation resource arrangement plan, the vehicle canceled from the preset transportation resource arrangement plan, an operation time of the vehicle, a transportation time of the driver, an assigned area of the driver, a loading work of the article based on the order, an alignment work of the article based on the order, a time of the loading work of the shipping worker, and a time of the alignment work of the shipping worker.

11. The transportation planning method according to claim 8, wherein
the storage unit stores a weight coefficient of the change amount of the distribution cost and a weight coefficient of the distribution cost,
in the second step, the control unit calculates a weighted sum using the weight coefficient of the change amount of the distribution cost when the transportation resource arrangement draft plan is adopted with respect to the distribution cost based on the preset transportation resource arrangement plan and the weight coefficient of the distribution cost when the transportation resource arrangement draft plan is adopted, and
the transportation planning method further comprises:
a third step of the control unit specifying a transportation draft plan implemented by the transportation resource arrangement draft plan in which the weighted sum is minimum.

12. The transportation planning method according to claim 11, wherein
the transportation resource information includes vehicle information related to a vehicle available for transportation of the article, driver information related to a driver available for driving of the vehicle, and shipping worker information related to a shipping worker available for a work of loading the article on the vehicle, and
the transportation resource arrangement draft plan includes information on the vehicle, the driver, and the shipping worker used for the transportation of the article based on the order, and
the transportation planning method further comprises:
a fourth step of the control unit transmitting the transportation resource arrangement draft plan and the transportation draft plan to an in-vehicle terminal of the vehicle included in the transportation draft plan implemented by the transportation resource arrangement draft plan in which the weighted sum is minimum and a management terminal for managing the shipping work of the shipping worker included in the transportation resource arrangement draft plan.

13. The transportation planning method according to claim 12, wherein
a display unit connected to the control unit, and the in-vehicle terminal and the management terminal connected to the control unit via a network are further provided,
in the fourth step, the display unit displays at least one of the transportation resource arrangement draft plan in which the weighted sum is minimum, the preset transportation resource arrangement plan, the change amount of the distribution cost, the distribution cost, the distribution cost for each transportation resource when each of the transportation resource arrangement draft plan in which the weighted sum is minimum and the preset transportation resource arrangement plan is adopted, and a transportation draft plan implemented by the transportation resource arrangement draft plan in which the weighted sum is minimum,
in the fourth step, the in-vehicle terminal outputs a transportation draft plan related to the vehicle on which the in-vehicle terminal is mounted among the transportation draft plan in which the weighted sum is minimum, and
in the fourth step, the management terminal outputs an arrangement draft plan related to a management target of the management terminal among the transportation resource arrangement draft plan in which the weighted sum is minimum.

14. The transportation planning method according to claim 8, wherein
the transportation resource information includes vehicle information related to a vehicle available for transportation of the article, driver information related to a driver available for driving of the vehicle, and shipping worker information related to a shipping worker available for a work of loading the article on the vehicle,
the transportation resource arrangement draft plan includes information on the vehicle, the driver, and the shipping worker used for the transportation of the article based on the order,
the storage unit further stores at least one of base information indicating an area to which abase of the transportation of the article belongs, movement cost information indicating a movement time from a transportation source to a transportation destination of the article, preparation progress information indicating a progress status of a work based on the transportation resource arrangement plan, unit price information for each of the vehicle, a cancellation fee for each of the vehicle, unit price information for each of the driver, assigned area information for each of the driver, a transportation error risk coefficient indicating a magnitude of a risk of a transportation error for each of the driver, unit price information for each of the shipping worker, a shipping error risk coefficient indicating a magnitude of a risk of a shipping error for each of the shipping worker, delay fee information indicating delay fee generated when the transportation is delayed, and damage compensation information indicating damage compensation generated for damage caused by the transportation,
in the first step, the control unit generates, based on at least one of the transportation amount information, the transportation resource information, the base information, the movement cost information, and the preparation progress information, a plurality of transportation draft plans for the article based on the order using the transportation resource available for the transportation of the article, and generate, for each of the transportation draft plans, a transportation resource arrangement draft plan for implementing the transportation, and
in the second step, the control unit calculates, based on at least one of the transportation resource arrangement plan information, the unit price information for each of the vehicle, the cancellation fee, the unit price information for each of the driver, the assigned area information, the transportation error risk coefficient, the unit price information for each of the shipping worker, the shipping error risk coefficient, the delay fee information, and the damage compensation information, a change amount of a distribution cost when the transportation resource arrangement draft plan is adopted with respect to the distribution cost based on the preset transportation resource arrangement plan, for each of the plurality of transportation resource arrangement draft plans.
